(19) United States
(12) Patent Application Publication
(10) Pub. No.: US 2004/0152451 A1
(43) Pub. Date: Aug. 5, 2004

(54) System and method for storing data of mobile communication terminal

(75) Inventor: Won-Pyo Park, Seoul (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/757,899

(22) Filed: Jan. 14, 2004

(30) Foreign Application Priority Data
Jan. 29, 2003 (KR) 6010/2003

(51) Int. Cl. H04M 11/00

(52) U.S. Cl. 455/412.1

(57) ABSTRACT

Disclosed are a method and a system for storing data of a mobile communication terminal having a wireless access to the Internet function. The mobile communication terminal includes a camera, a memory, and an image processing unit for processing an image captured by the camera to generate image data. An image data storage mode set in the mobile communication terminal is detected when the camera starts an image capturing operation. It is determined whether to access the Internet via a wireless connection according to the detected image data storage mode. A wireless Internet access is performed according to the determination result. The image data generated from the image processing unit is transmitted in real time to a remotely-located file storage device having a memory through the wireless Internet connection.

### PRIORITY

This application claims priority to an application entitled “SYSTEM AND METHOD FOR STORING DATA OF MOBILE COMMUNICATION TERMINAL”, filed in the Korean Industrial Property Office on Jan. 29, 2003 and assigned Serial No. 2003-6010, the contents of which are hereby incorporated by reference.

### BACKGROUND OF THE INVENTION

1. Field of the Invention

The present invention relates to a system and a method for storing data of a mobile communication terminal, which has a wireless access to the Internet, and includes a camera, a memory, and an image processing unit for processing an image captured by the camera and generating image data.

2. Description of the Related Art

A general use mobile communication system, e.g., a cell phone, has been developed for providing voice communication services while securing mobility and convenience of portability for users. With development of communication technologies, there have been available data services such as Internet service, a service of transmitting music data files) for sounds, e.g., a bell sound, and a SMS (Short Message Service), as well as voice communications. Demand for such data services is on the rise, particularly for large-capacity data transmission services at high speed. One mobile communication system developed to meet such demands is a CDMA (Code Division Multiple Access) 2000 communication system with an improved data rate.

The most remarkable of various functions currently developed for CDMA 2000 terminals is a function of processing image data, such as a moving image. A mobile communication terminal having such image data processing function is currently available for sale. This mobile communication terminal includes a camera externally or internally mounted on the mobile communication terminal, and an internal memory for storing image data of a moving image and a photograph captured by the camera. However, image data of a moving image and photographs have very high data volume, as compared to text data, while a mobile communication terminal, such as a cell phone, uses an internal memory of a relatively small storage capacity in consideration of the cost and size of the mobile communication terminal. This small storage capacity of the internal memory of the mobile communication terminal causes users' inconvenience because it cannot satisfy users' desires for capturing many photographs and moving images.

### SUMMARY OF THE INVENTION

Therefore, the present invention has been made in view of the above problem. It is an object of the present invention to provide a system and a method for storing data of a mobile communication terminal, whereby image data collected by the mobile communication terminal can be stored in real time in a remotely-located storage space having a memory, as well as in an internal memory of the mobile communication terminal.

In accordance with one aspect of the present invention, the above and other objects can be accomplished by the provision of a method for storing data of a mobile communication terminal having a wireless access to the Internet, the mobile communication terminal includes a camera, a memory, and an image processing unit for processing an image captured by the camera to generate image data. The method comprises the steps of: a) detecting a set image data storage mode when the camera starts an image capturing operation; b) determining whether to access the Internet through a wireless connection according to the detected image data storage mode; c) performing a wireless connection to the Internet according to the determination result; and d) transmitting in real time the image data generated from the image processing unit to a remotely-located file storage device having a memory via the wireless connection to the Internet.

In accordance with another aspect of the present invention, there is provided a system for storing image data of a mobile communication terminal including a camera for capturing an image and an image processing unit for processing the image captured by the camera to generate image data. The system comprises a file storage device including a data storage section and a base/control station for assigning a source IP address to the mobile communication terminal in response to an image data storage request signal from the mobile communication terminal, wherein the base/control station gains access to the file storage device with destination IP address information included in data transmitted from the mobile communication terminal, and transmits in real time the image data from the mobile communication terminal to the file storage device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the configuration of a data storage system for mobile communication terminals, according to the present invention;

FIG. 2 is a view showing the internal configuration of a mobile communication terminal in FIG. 1;

FIG. 3 is a view showing a screen for selecting an image data storage mode, which is displayed on a display unit in FIG. 1;

FIG. 4 is a view showing the structure of packet data used for transmitting image data from the mobile communication terminal, according to the present invention;

FIG. 5 is a flow chart illustrating the procedure of setting the image data storage mode of the mobile communication terminal, according to the present invention;

FIG. 6 is a flow chart illustrating the procedure for controlling the mobile communication system in a method for storing image data of the mobile communication system, according to the present invention;

FIG. 7 is a view illustrating signal flows in a network for storing image data in a file storage server; and

FIG. 8 is a flow chart illustrating a method for storing image data of a mobile communication terminal, according to a different embodiment of the present invention.

### DETAILED DESCRIPTION OF THE PREFERRED EMBODIMENTS

Now, preferred embodiments of the present invention will be described in detail with reference to the annexed drawings.

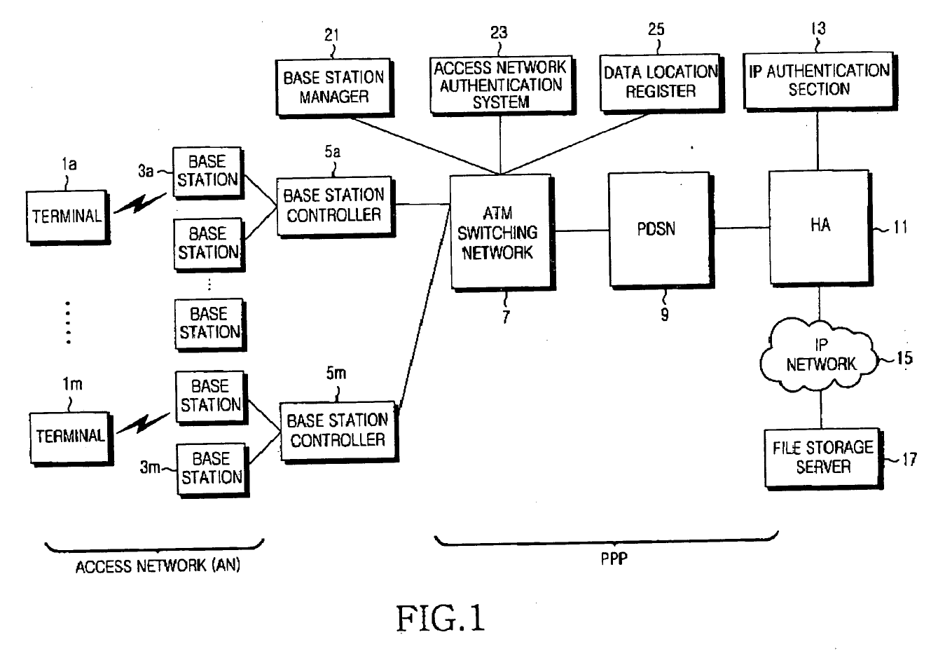

FIG. 1 is a view showing the configuration of a data storage system for mobile communication terminals, according to the present invention. As shown in FIG. 1, mobile communication terminals 1a to 1m perform high data-rate communication with base stations 3a to 3m through wireless channels preset according to a CDMA 2000 standard. Each of base stations 3a to 3m performs data communication with mobile communication terminals 1a to 1m through wireless channels, and are connected by wire to base station controllers 5a to 5m. An Asynchronous Transfer Mode (ATM) switching network 7 connected by wire to the base station controllers 5a to 5m is connected to a base station manager 21, a network authentication system 23, and a data location register 25. The base station manager 21 performs an authentication process for a number of the base station controllers 5a to 5m. The data location register 25 performs functions similar to a home agent location register in a CDMA 2000 system that provides services centered on voice data.

Base station controllers 5a to 5m process data transmitted to and received from mobile communication terminals 1a to lm. The network authentication system 23 and the data location register 25 perform signal processing such as user authentication through the ATM switching network 7.

Base stations 3a to 3m and base station controllers 5a to 5m form an access network. The access network is connected by wire to the ATM switching network 7, so as to communicate with a file storage server 17, as a file storage device according to the present invention, through a Packet Data Service Node (PSDN) 9.

The ATM switching network 7 controls transmission and reception of packet data to and from mobile communication terminals 1a to 1m, and performs a packet processing for data received from mobile communication terminals 1a to 1m and then transmits it to the PSDN 9. Thus, in a wired line, communication is performed in a stage downstream from the ATM switching network 7 through a packet-based data of a different format, from a packet-based data processed at a stage upstream of the ATM switching network 7. This is because a data communication protocol of a wireless network is different from that of a wired network. The PDSN 9 is connected to an IP authentication section 13 through a Home Agent (HA) 11 that manages data of data terminals. The IP authentication section 13 performs an authentication of packet data services for data terminals. The HA 11 is connected to the IP network 15 to perform data processing in accordance with the Internet protocol. HA 11 has access to the file storage server 17, which serves as a file storage device of the present invention, through the IP network 15.

The file storage device 17 includes a data storage device, having an IP address that can gain access to the Internet, such as a remotely-located computer connected to the Internet and a mail storage server provided by a mobile communication provider for storing mails transmitted from mobile communication terminals.

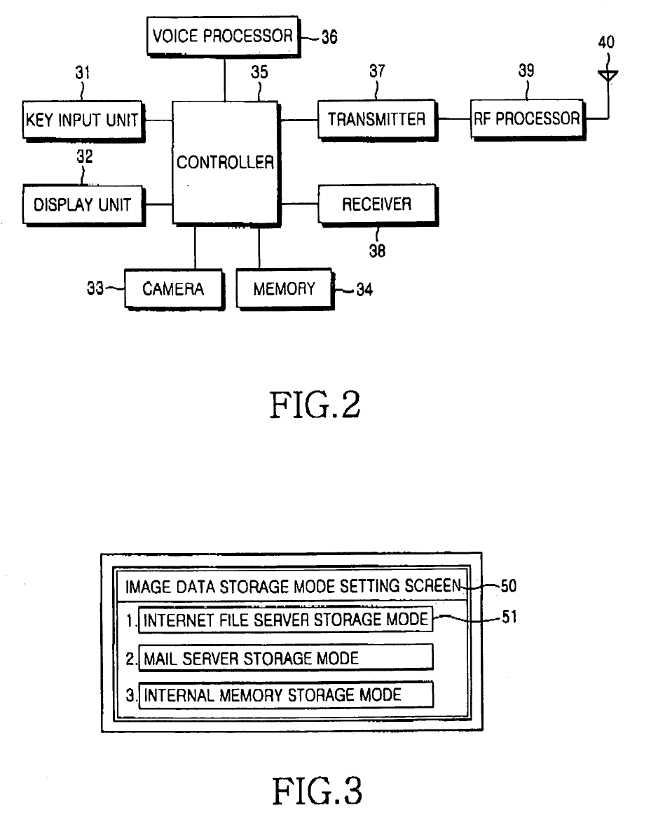

FIG. 2 is a view showing internal configuration of the mobile communication terminal of FIG. 1. As shown in FIG. 2, the mobile communication terminal 1 includes a key input unit 31 for receiving a key input from a user, a display unit 32 for providing a graphic user interface, a transmitter 37, and a receiver 38. The mobile communication terminal 1 further includes a voice processing unit 26, a RF processing unit 39, a camera 33, a memory 34, and a controller 35. The voice processing unit 26 processes voice data transmitted and received by the transmitter 37 and receiver 38, respectively. The RF processing unit 39 converts data into a high-frequency signal. The camera 33 is used for capturing photographs and moving pictures. The controller 35 controls the overall operation of the mobile communication terminal, such as voice and data transmission and reception.

In more detail, the key input unit 31 includes digit keys, a menu key, and a send key (or a call transmission key).

The voice processing unit 36 digitizes an inputted and outputted analog sound signal or processes digital sound data stored in the memory 34 into a corresponding analog signal and then outputs it.

The transmitter 37 modulates an inputted signal into a form suitable for transmission and provides it to the RF processing unit 39. The RF processing unit 39 transmits the signal from the transmitter 37 through an antenna 40, and transfers the signal received through the antenna 40 to the receiver 38 for demodulation of the received signal.

The display unit 32 is composed of an LCD (Liquid Crystal Display Unit), an LED, etc. The camera 33 captures a photograph, a moving image, etc., and generates corresponding image data. Hereinafter, still and moving image data is referred to as image data.

The memory 34 stores various kinds of data generated from the mobile communication terminal, such as, for example, short message service (SMS) data and image data of a photograph, a moving image, etc. According to the present invention, the memory 34 also stores as destination IP address information, the IP address of the file storage server 17 which will be accessed via the Internet for storing the photograph and moving image captured by the camera 33. The mobile communication terminal stores a photograph or a moving image in the memory 34. Alternatively, by gaining access to the Internet through the transmitter 39 and the RF processing unit 39 using the IP address stored in the memory 34, the mobile communication terminal stores image data captured by the camera 33 in real time in the file storage server 17 having the stored IP address. In a similar manner to the above Internet storage method, the captured photograph or moving image may be generated in email form and then transmitted through the transmitter 37 and the RF processing unit 39 to be stored in the email storage server 17.

When the user selects a menu key in the key input unit 31, the controller 35 allows the display unit 32 to display a user menu screen that includes an icon for setting an image data storage mode. When it is detected that this storage mode setting icon is selected according to the user's manipulation of the key input unit 31, the controller 35 allows the display unit 32 to display a screen 50 for setting the image data storage mode as shown in FIG. 3. This storage mode setting screen 50 includes an option list of selectable image data storage modes, such as a mode of storing in an Internet file server, also referred to as “an Internet file server storage mode” 51, a mode of storing in an email server, also referred to as “an email server storage mode” 53, and a mode of storing in an internal memory, also referred to as “an internal memory storage mode” 55.

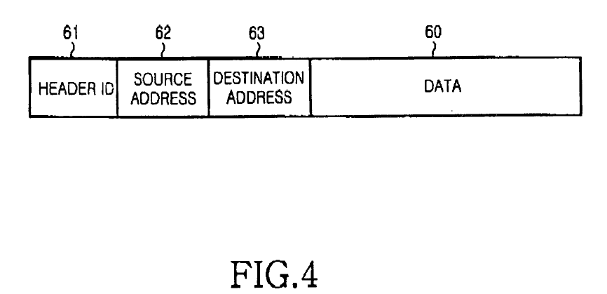

FIG. 4 is a view showing the structure of packet data used for transmitting image data from a mobile communication terminal, according to the present invention. As shown in FIG. 4, the packet data for image data transmission includes a header ID 61, a source IP address 62, a destination IP address 63, and image data 60. The controller 35 transmits the packet data shown in FIG. 4, including the image data, to the file storage devices located throughout the Internet, so as to allow image data generated by a camera of the mobile communication terminal to be transmitted to a file storage device having a desired destination IP and stored in an allocated data storage space.

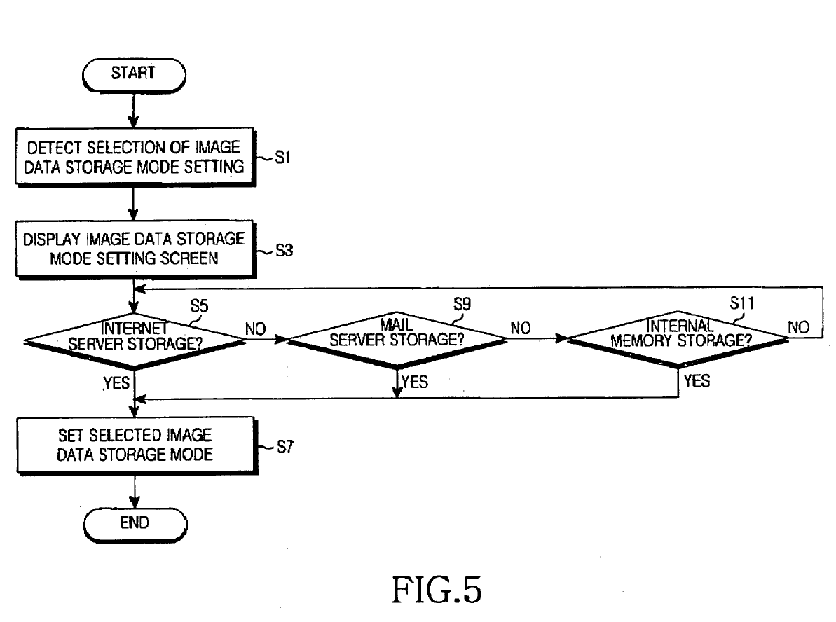

FIG. 5 is a flow chart illustrating the procedure of setting the image data storage mode of the mobile communication terminal, according to the present invention. Firstly, as the user manipulates the key input unit 31 of the mobile communication terminal for setting the image data storage mode, the controller 35 detects a signal for selecting the image data storage mode, at step S1. At step S3, in response to this detection, the operation mode of the mobile communication terminal switches to a mode for setting the image data storage mode. In this mode, the screen 50 used for setting the image data storage mode supportable by the mobile communication terminal is displayed on the display unit 32, as shown in FIG. 3. When the user manipulates the key input unit 31 according to a desired image data storage mode, referring to the storage mode setting screen 50, the controller 35 receives, from the key input unit 31, one of an input for selecting “1. An Internet file server storage mode” 51 at step S5, an input for selecting “2. An email server storage mode” 53 at step S9, and an input for selecting “3. An internal memory storage mode” 55 at step S11. At step S7, the controller 35 stores information regarding an image data storage mode selected and inputted by the key input unit 31, as storage mode setting information, in the internal memory 34. The storage mode setting mode is provided to the user in such a manner that a menu list of image data storage modes is displayed on the screen, or a corresponding voice menu is outputted so that the user may always easily manipulate the setting mode.

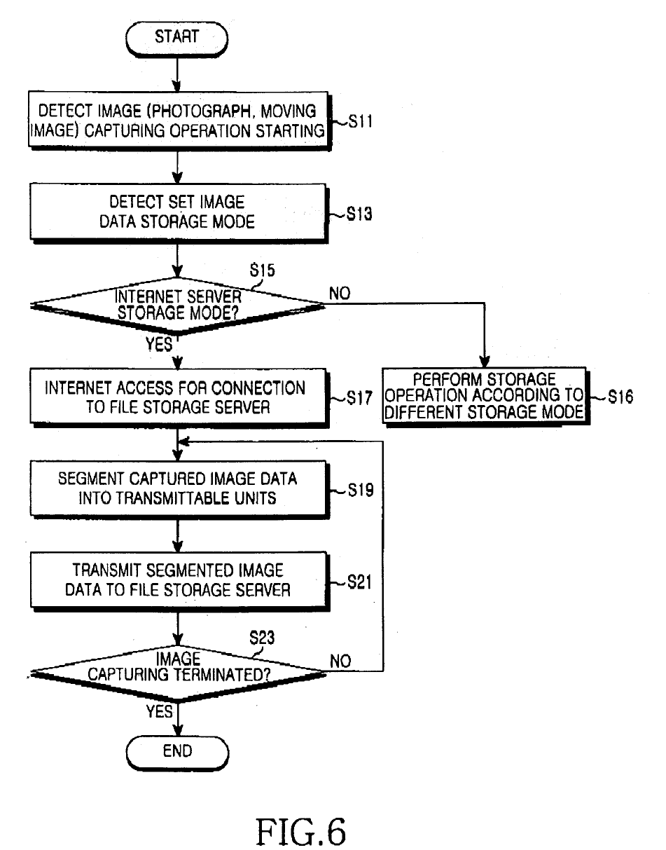

FIG. 6 is a flow chart illustrating the procedure for controlling a mobile communication system in a method for storing image data of a mobile communication system according to the present invention. Firstly, as the camera 33 mounted on the mobile communication terminal operates, the controller 35 detects at step S11 that the operation of capturing an image, such as a photograph or a moving image, has started. At step S13, the controller 35 detects information regarding an image data storage mode stored in the internal memory 34. If it is determined at step S15 that the stored image data storage mode is not an Internet file server storage mode, a storage operation is performed according to a different storage mode instep S16. Otherwise, when the stored image data storage mode is an Internet file server storage mode, the controller 35 requests an approval of image data transmission from the base station 3a. Then, the mobile communication terminal gains wireless access to the Internet with a source IP address provided from the base station 3a. At step S17, the controller 35 detects a destination IP address stored in the internal memory 34, and incorporates the detected destination IP address, the source IP address provided from the base station 3a, and the image data generated from the camera 33 into packet data as shown in FIG. 4, and then transmits the packet data. The destination IP address may be previously stored in the mobile communication terminal, or may be newly inputted when having access to the Internet.

When receiving the packet data from the mobile communication terminal, the base station 3a and the base station controller 5a perform a user authentication process to confirm whether the mobile communication terminal's user is a subscriber of the image data storage service. After performing the user authentication process via the ATM switching network 7 and the network authentication system 23, the base station controller 5a transmits image data to the PDSN (Packet Data Service Node) 9. The PDSN 9 converts the received image data into packet data transmittable to a wired network, and then transmits it to the HA 11. On the basis of the source IP address transmitted together with the image data, the HA 11 performs a user authentication process through the IP authentication section 13 to check whether the mobile communication terminal's user is a subscriber of the image data storage service. If the authentication result is that the mobile communication terminal's user is a subscriber, the HA 11 transmits the image data to the file storage server 17 having the destination IP address through the IP network 15. For this image data transmission, the mobile communication terminal's controller 35 segments the image data, captured by the camera 33, into transmittable units at step S19, and, at step S21, transmits the segmented image data to the file transmission server 17 through the above procedure. Next, at step S23, the controller 35 judges whether the image capturing operation of the mobile communication terminal has been finished. If the image capturing operation has been finished, the ongoing procedure is finished, otherwise the procedure returns to step 19 to continuously transmit captured image data to the file storage server 17 and store it in the file storage server 17.

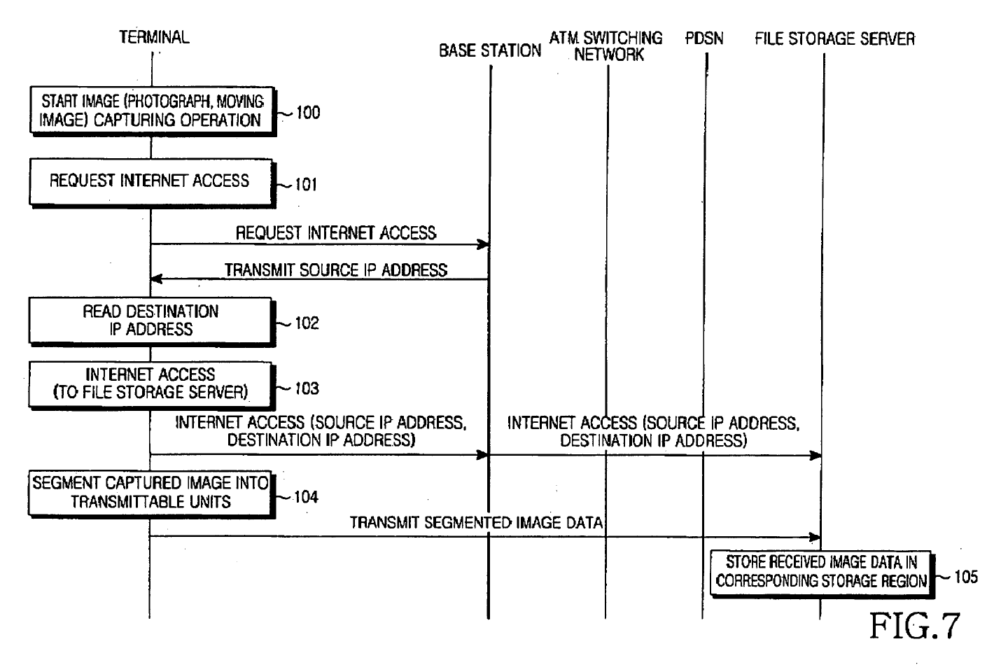

Now, referring to FIG. 7, signal flows in the network will be described in the case where a mode of storing image data in a file storage server, including an Internet file server and an email server, is set as the image data storage mode in the mobile communication terminal. As shown in FIG. 7, when the mobile communication terminal's camera starts an image capturing operation at step S1100, the controller 35 reads a destination IP address used for storing image data from the memory 34, and gains access to a file storage server 17 having the read destination IP address. The process for gaining access to the file storage server 17 by the mobile communication terminal is performed as follows. At step 101, the mobile communication terminal requests an image data transmission. At step 102, the mobile communication terminal receives a source IP address from a base station. At step 103, Internet access is requested to the base station controller 5a, while using the received IP address as a source IP address and the IP address of the file storage server 17 as a destination address. At this time, the ATM switching network 7 performs an authentication process with the mobile communication terminal, on the basis of a user ID, a secret number, etc. If the user authentication is completed, at step 104, the base station controller 5a has access to the PDSN 9 through the ATM switching network 7 according to Point to Point Protocol (PPP), so as to complete an Internet connection between the mobile communication terminal and the PDSN 9. When the connection with the file storage server 9 is completed in such a manner, at step 104, the mobile communication terminal's controller 35 segments image data captured by the camera 33 into transmittable units through a reverse link, and then transmits it to the HA 11 through the base station controller 5a, the ATM switching network 7, and the PDSN 9. After performing an IP authentication process through the IP authentication section 13, the HA 11 transmits the image data to the file storage server 17 through the IP network. In response to this image data transmission, the file storage server 17 stores the image data received from the mobile communication terminal in a corresponding storage region of the file storage server 17, at step 105.

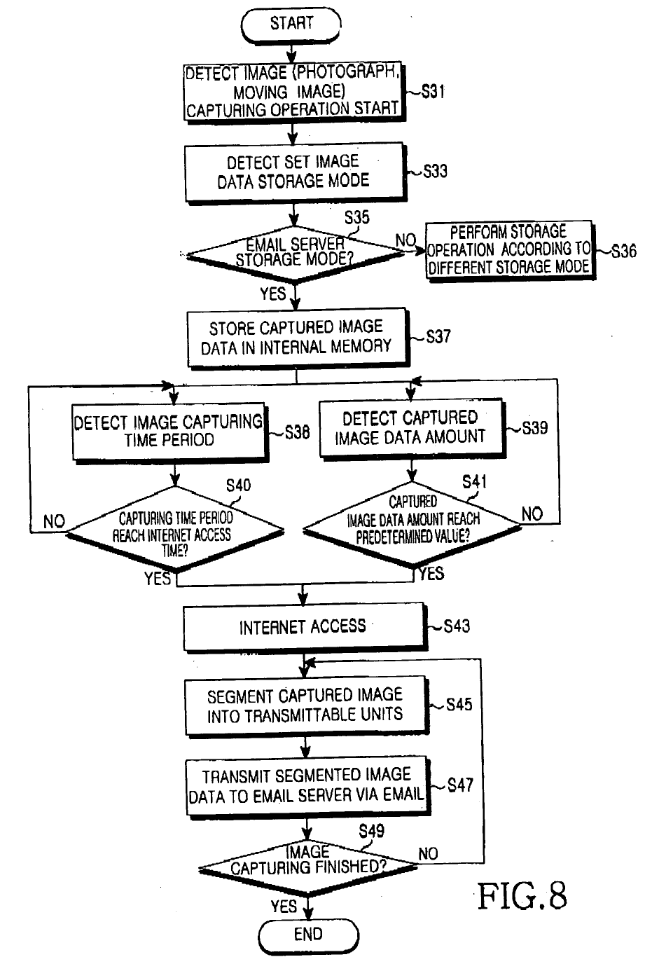

FIG. 8 is a flow chart illustrating a method for storing image data of a mobile communication terminal in the case where an email server storage mode is selected from the image data storage mode selection screen as shown in FIG. 3. In this embodiment, image data generated after the camera starts the image capturing operation is firstly stored in the internal memory, and thereafter when the current condition becomes an image data transmission condition, the mobile communication terminal gains access to the Internet and transmits in real time the image data to an email server via email. Preferably, the image data transmission condition can be classified into the case where the amount of image data captured after the camera starts the image capturing operation reaches a predetermined value, and the case where the period of time while the camera captures image (hereinafter, referred to as an “image capturing period of time”) corresponds to an Internet access point of time. As shown in FIG. 8, with the operation of the camera 33 provided in the mobile communication terminal, the controller 35 detects at step S31 that the operation of capturing images, such as a photograph and a moving image, has started.

Then, at step S33, the controller 35 detects information regarding the image data storage mode stored in the internal memory 34. If it is determined at step S35 that the detected image data storage mode is not “an email server storage mode”, the storage operation is performed to different storage mode in step S36. Otherwise, the controller 35 stores image data generated from the camera in the internal memory at step S37. Thereafter, in order to determine whether the current condition becomes a condition for transmitting image data generated by the camera via email, the image capturing period of time is detected at step S38, or the amount of the captured image data is detected at step S39. When it is determined at step S40 that the image capturing period of time corresponds to the Internet access time to meet the email transmission condition, the mobile communication terminal automatically enables wireless access to the Internet. Otherwise, if it is determined at step S40 that the image capturing period of time does not correspond to the Internet access time the control is returned to step S38 until such time arrives. After the image captured by the camera is segmented into transmittable units at step S45, the captured image data is transmitted in real time to the email server via email at step S47. Also when it is determined at step S41 that the amount of image data captured after the camera starts the image capturing operation reaches the predetermined value, the image data captured by the camera is transmitted in real time to the email server via email through steps S43 to S47. If, however, it is determined at step S41 that the amount of image data captured after the camera starts the image capturing operation did not reach the predetermined value, the control is returned to step S39 until such predetermined value is reached. Thereafter, the controller 35 determines at step S49 whether the image capturing operation of the camera 33 has been finished. If the image capturing operation has been finished, the ongoing procedure is finished, and, if not, the procedure returns to step S45 to transmit the captured image data to the email server and store it in the email server.

In addition, the case where the amount of image data stored in the internal memory reaches a predetermined value, or the remaining storage space of the internal memory is lower than a predetermined value, can be considered as an email transmission condition different from the above email transmission condition. To this end, the amount of image data stored in the internal is detected, and if it is determined that the current condition becomes the different email transmission condition, the mobile communication terminal intermittently gains wireless access to the Internet and transmits the image data generated by the camera to the email server via email.

Furthermore, the image data stored in the file storage server 17 can be downloaded by means of a conventional download function through the wireless connection to the Internet, and a detailed description thereof is omitted.

The file storage server according to the above embodiments may include an Internet-accessible personal computer or portable mobile communication terminal, etc., which has memory.

As seen from the above description, the present invention provides a system and a method for storing data collected by a mobile communication terminal, wherein image data generated from a camera of the mobile communication terminal can be stored in a storage space connected to the Internet in real time, thereby overcoming problems resulting from a limited storage capacity of an internal memory of the mobile communication terminal. In addition, even though an unused storage capacity of the memory is small, such small capacity has no effect on storing a desired amount of image data, thereby achieving a large-capacity image data storage at a low cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for storing data of a mobile communication terminal having a wireless access to the Internet, the terminal including a camera, memory, and an image processing unit for processing images captured by the camera to generate image data, the method comprising the steps of:
a) detecting an image data storage mode when the camera starts an image capturing operation;
b) determining whether to use wireless access to the Internet according to the detected image data storage mode;
c) performing a wireless access to the Internet according to the determination result; and
d) transmitting in real time image data generated by the image processing unit to a remotely-located file storage device having a memory via the wireless access to the Internet.

2. The method as set forth in claim 1, wherein step c) includes the steps of:
c-1) receiving a source IP address for Internet access from a base station; and
c-2) obtaining a destination IP address of the file storage device.

3. The method as set forth in claim 1, further comprising the step of receiving a user authentication of the terminal from the file storage device.

4. The method as set forth in claim 1, further comprising the step of storing image data transmitted from the terminal in a storage region of the file storage device, the storage region corresponding to a user identification value included in image data transmitted from the terminal.

5. The method as set forth in claim 1, wherein step d) of transmitting image data includes the step of segmenting image data into packet data of a predetermined size and transmitting image data.

6. The method as set forth in claim 1, further comprising the step of providing a menu for setting image data storage mode.

7. The method as set forth in claim 6, wherein the menu includes selectable image data storage modes of an internal memory storage mode, an Internet file storage server storage mode, and an email server storage mode.

8. The method as set forth in claim 7, wherein the Internet file storage server includes a user computer having a unique IP address.

9. The method as set forth in claim 8, further comprising the steps of:
e) if the set image data storage mode detected at the step a) is the email server storage mode, temporally storing image data, generated after the camera starts the image capturing operation, in memory;
f) detecting the amount of image data generated from the camera and determining whether the detected amount of image data is a predetermined value for Internet access; and
g) if the determination result of step f) is that the detected amount of image data is the predetermined value, automatically gaining wireless access to the Internet and transmitting in real time image data to the remotely-located file storage device having memory.

10. The method as set forth in claim 9, wherein the amount of image data generated from the camera is detected, and if the detected amount of image data is the predetermined value for Internet access, step g) includes the step of intermittently gaining wireless access to the Internet.

11. A system for storing image data of a mobile communication terminal including a camera for capturing an image and an image processing unit for processing the image captured by the camera to generate image data, the system comprising:
a file storage device including a data storage section; and
a base station for transmitting a source IP address to the mobile communication terminal, in response to an image data storage request signal from the mobile communication terminal,
wherein the base station gains access to the file storage device with destination IP address information included in data transmitted from the mobile communication terminal, and transmits in real time image data from the mobile communication terminal to the file storage device.

12. The system as set forth in claim 11, wherein the mobile communication terminal includes:
a wireless transmission/reception section;
a memory for storing an IP address of the file storage device; and
a controller for a), when the camera starts an image capturing operation, requesting an Internet transmission from the base station to receive a source IP address assigned by the base station, b) detecting the IP address of the file storage device, and c) gaining access to the IP address through the wireless transmission/reception section.

13. The system as set forth in claim 12, wherein the file storage device includes a data storage section in which a storage region is assigned according to a user identification value of the mobile communication terminal.

14. The system as set forth in claim 13, wherein the file storage device includes a user computer having a unique IP address.
